(19) United States
(12) Patent Application Publication
(10) Pub. No.: US 2024/0254830 A1
(43) Pub. Date: Aug. 1, 2024

(54) CONTAIN AND DRAIN SILL SYSTEMS

(71) Applicant: ANDERSEN CORPORATION, Bayport, MN (US)

(72) Inventors: Adam Rietz, Lakeland, MN (US); Allen DaRonco, Somerset, WI (US); Christopher Hanson, Fridley, MN (US)

(21) Appl. No.: 18/520,799

(22) Filed: Nov. 28, 2023

Related U.S. Application Data
(60) Provisional application No. 63/441,545, filed on Jan. 27, 2023.

(51) Int. Cl. E06B 7/14; E06B 3/46; E06B 7/10

(52) U.S. Cl. CPC E06B 7/14; E06B 3/4609; E06B 7/10

(57) ABSTRACT

Contain and drain sill systems and fenestration unit incorporating the sills along with related methods are described herein. The contain and drain sill systems and fenestration units incorporating them provide enhanced water performance by separating drainage from interior and exterior sides of the fenestration unit and sill system.

### RELATED APPLICATION

The present application claims the benefit under 35 U.S.C. § 119(e) of U.S. Provisional Patent Application 63/441,545 filed on Jan. 27, 2023, which is hereby incorporated by reference in its entirety.

Contain and drain sill systems and fenestration unit incorporating the sills along with related methods are described herein.

Water management features and systems are provided in some fenestration unit sills to contain and drain water collected in the sills during storms or other water events. Although designed to contain and drain water, some sills struggle to adequately handle larger volume events.

### SUMMARY

Contain and drain sill systems and fenestration unit incorporating the sills along with related methods are described herein.

The contain and drain sill systems and fenestration units incorporating them provide enhanced water performance that may be particularly beneficial for fenestration units exposed to extreme weather events such as, e.g., tropical storms, hurricanes, cyclones, thunderstorms, rainstorms, etc. in which larger volumes of water are directed onto the fenestration units described herein.

In one or more embodiments, the contain and drain sill systems can provide fenestration units that achieve higher water performance by separating drainage from interior and exterior sides of the fenestration unit and sill system. The contain and drain sill systems described herein drain water from an exterior drainage zone located on the exterior side of a fenestration unit using a completely separate water path from the path followed by water drained out of an interior drainage zone located on the interior side of the fenestration unit.

In one or more embodiments, the separate containment tanks for both interior and exterior side drainage can extend along the entire length of the sill which provides an increased volume for the containment tanks as compared to sill drainage systems that include containment tanks that occupy only a portion of the length of a sill. That increased volume can further enhance drainage performance of the contain and drain sill systems described herein.

Drainage from, for example, the interior drainage zone of a contain and drain sill as described herein may be further enhanced by an increased water column height available in one or more embodiments of the contain and drain sill systems described herein. The increased water column height may, for example, improved drainage even during high wind events that may otherwise slow or limit drainage.

One or more embodiments of the contain and drain sill systems described herein may also include various features configured to improve air management within the sills to, for example, reduce percolation, bubbling, etc. and/or improve drainage. In one or more embodiments, the air management features may be aligned along a horizontal axis extending between the interior and exterior sides of the sill to provide for easier/improved movement of air through the containment tanks of the sill systems described herein.

The contain and drain sill systems can, in one or more embodiments, increase water performance with a relatively short sill height.

Separation of the interior and exterior drainage can, in one or more embodiments, be achieved in a relatively easy process of fabrication and manufacture involving conventional tooling.

In a first aspect, one or more embodiments of a contain and drain sill system for a fenestration unit as described herein includes: a window or door frame comprising a first side jamb and a second side jamb connected to each other by a head jamb and a sill, wherein the sill and the frame comprise an interior side and an exterior side; an inner panel retained in the frame, the inner panel positioned above the sill and between the first side jamb and the second side jamb; an outer panel retained in the frame, the outer panel positioned above the sill and between the first side jamb and the second side jamb; an inner rail extending along a length of the sill between the first side jamb and the second side jamb, wherein the inner panel is supported by the inner rail; an outer rail extending along a length of the sill between the first side jamb and the second side jamb, wherein the outer panel is supported by the outer rail, wherein the outer rail is located between the inner rail and the exterior side of the sill; an inner trough located in the sill, the inner trough located between the interior side of the sill and the inner rail; an outer trough located in the sill, the outer trough located between the inner rail and the outer rail; a containment tank located in the sill, wherein the containment tank is located below the inner rail, the outer trough and at least a portion of the inner trough; a plurality of trough drains located in the outer trough between the outer panel and the inner trough, wherein each trough drain of the plurality of trough drains is configured to drain water in the outer trough into the containment tank, wherein each trough drain comprises a conduit comprising an upper opening and a lower opening, wherein water draining from the outer trough into the containment tank enters the conduit through the upper opening and leaves the conduit to enter the containment tank through the lower opening; and a plurality of vents in the sill, wherein each vent of the plurality of vents comprises a vent opening extending through an exterior wall of the inner rail and is in fluid communication with the containment tank.

In one or more embodiments of a contain and drain sill system as described herein, the containment tank extends along the length of the sill from the first side jamb to the second side jamb.

In one or more embodiments of a contain and drain sill system as described herein, each vent opening of the plurality of vents is located below an upper support surface of the inner rail and above a bottom of the outer trough.

In one or more embodiments of a contain and drain sill system as described herein, at least one vent opening is aligned with each trough drain of the plurality of trough drains when moving along a horizontal axis extending through the at least one vent between the interior side and the exterior side of the sill. In one or more embodiments, the at least one vent opening aligned with each trough drain is located above the trough drain, and wherein the at least one vent opening is separate and discrete from the trough drain with which the at least one vent opening is aligned.

In one or more embodiments of a contain and drain sill system as described herein, two or more vent openings of the plurality of vents are aligned with each trough drain of the plurality of trough drains when moving along a horizontal axis extending through the two or more vent openings between the interior side and the exterior side of the sill. In one or more embodiments, the two or more vent openings aligned with each trough drain are located above each trough drain, and wherein the two or more vent openings are separate and discrete from the trough drain with which the two or more vent openings are aligned.

In one or more embodiments of a contain and drain sill system as described herein, each vent opening comprises a vent cover that comprises a plurality of grates extending across the vent opening.

In one or more embodiments of a contain and drain sill system as described herein, the conduit of each trough drain of the plurality of trough drains comprises a first conduit and wherein the trough drain comprises a second conduit comprising a second upper opening and a second lower opening, wherein a portion of water draining from the outer trough into the containment tank enters the second conduit through the second upper opening and leaves the second conduit to enter the containment tank through the second lower opening. In one or more embodiments, the first conduit and the second conduit are separated from each other by an air vent located between the first conduit and the second conduit, wherein the air vent is located below the upper opening of the first conduit and the second upper opening of the second conduit, and wherein the air vent is located above the lower opening of the first conduit and the second lower opening of the second conduit. In one or more embodiments, the air vent is located in the containment tank below the outer trough. In one or more embodiments, at least one vent of the plurality of vents is aligned with the air vent when moving along a horizontal axis extending through the at least one vent between the interior side and the exterior side of the sill.

In one or more embodiments of a contain and drain sill system as described herein, the sill comprises a plurality of weep drains in fluid communication with the containment tank such that water in the containment tank drains out of the containment tank through the plurality of weep drains under the force of gravity, wherein the plurality of weep drains are located on the exterior side of the sill, and wherein, for each trough drain of the plurality of trough drains, the lower opening of the conduit is located above each weep drain of the plurality of weep drains. In one or more embodiments, at least one trough drain of the plurality of trough drains is aligned with each weep drain of the plurality of weep drains when moving along a horizontal axis extending through the at least one trough drain between the interior side and the exterior side of the sill. In one or more embodiments, at least one vent opening is aligned with each weep drain of the plurality of weep drains when moving along a horizontal axis extending through the at least one vent opening between the interior side and the exterior side of the sill. In one or more embodiments, at least one trough drain of the plurality of trough drains is aligned with each weep drain of the plurality of weep drains when moving along a horizontal axis extending through the at least one trough drain between the interior side and the exterior side of the sill; wherein at least one vent opening is aligned with each weep drain of the plurality of weep drains when moving along a horizontal axis extending through the at least one vent opening between the interior side and the exterior side of the sill; and wherein the at least one vent opening is aligned with the at least one trough drain when moving along a horizontal axis extending through the at least one vent opening between the interior side and the exterior side of the sill.

In one or more embodiments of a contain and drain sill system as described herein, the conduit of each trough drain of the plurality of trough drains comprises a first conduit and wherein the trough drain comprises a second conduit comprising a second upper opening and a second lower opening, wherein a portion of water draining from the outer trough into the containment tank enters the second conduit through the second upper opening and leaves the second conduit to enter the containment tank through the second lower opening. In one or more embodiments, the first conduit and the second conduit are separated from each other by an air vent located between the first conduit and the second conduit, wherein the air vent is located below the upper opening of the first conduit and the second upper opening of the second conduit, and wherein the air vent is located above the lower opening of the first conduit and the second lower opening of the second conduit. In one or more embodiments, the air vent is located in the containment tank below the outer trough. In one or more embodiments, at least one weep drain of the plurality of weep drains is aligned with the air vent when moving along a horizontal axis extending through the at least one weep drain between the interior side and the exterior side of the sill.

In a second aspect, one or more embodiments of a method of controlling water captured in a sill of a fenestration unit as described herein includes: draining water collected in an outer trough of a sill to a containment tank, wherein the outer trough is located between an inner rail and an outer rail, wherein the inner rail and the outer rail both extend along a length of the sill, wherein the inner rail supports an inner panel of the fenestration unit and the outer rail supports an outer panel of the fenestration unit, and wherein the draining occurs through a plurality of trough drains located in the outer trough between an outer panel and the inner rail, and wherein the containment tank is located below the inner rail of the sill and the outer trough; draining water from the containment tank to an exterior side of the sill through a plurality of weep drains in the sill; and venting air from the containment tank through a plurality of vents, wherein each vent of the plurality of vents comprises a vent opening extending through a wall of the inner rail that is in fluid communication with the containment tank.

In one or more embodiments a method of controlling water captured in a sill of a fenestration unit as described herein, the containment tank extends along the length of the sill.

In one or more embodiments a method of controlling water captured in a sill of a fenestration unit as described herein, each trough drain of the plurality of trough drains is located closer to the inner rail than an outer rail when moving along a horizontal axis extending between the interior side and the exterior side of the sill, wherein the outer rail is located between the outer trough and the exterior side of the sill.

In one or more embodiments a method of controlling water captured in a sill of a fenestration unit as described herein, at least one vent of the plurality of vents is aligned with each trough drain of the plurality of trough drains when moving along a horizontal axis extending through the at least one vent between the interior side and the exterior side of the sill. In one or more embodiments, the at least one vent aligned with each trough drain is located above the trough drain, and wherein the at least one vent is separate and discrete from the trough drain with which the at least one vent is aligned.

In one or more embodiments a method of controlling water captured in a sill of a fenestration unit as described herein, two or more vents of the plurality of vents are aligned with each trough drain of the plurality of trough drains when moving along a horizontal axis extending through the two or more vents between the interior side and the exterior side of the sill. In one or more embodiments, the two or more vents aligned with each trough drain are located above each trough drain, and wherein the two or more vents are separate and discrete from the trough drain with which the two or more vents are aligned.

In one or more embodiments a method of controlling water captured in a sill of a fenestration unit as described herein, each vent of the plurality of vents comprises a vent cover that comprises a plurality of grates extending across the vent opening.

In one or more embodiments a method of controlling water captured in a sill of a fenestration unit as described herein, each trough drain comprises a first conduit and a second conduit, wherein a portion of water draining from the outer trough into the containment tank passes through the first conduit or the second conduit, and wherein a portion of air in the containment tank passes through an air vent located between the first conduit and the second conduit when moving towards the interior side of the sill. In one or more embodiments, the air vent is located in the containment tank below the outer trough. In one or more embodiments, at least one vent of the plurality of vents is aligned with the air vent when moving along a horizontal axis extending through the at least one vent between the interior side and the exterior side of the sill.

In one or more embodiments a method of controlling water captured in a sill of a fenestration unit as described herein, each trough drain of the plurality of trough drains comprises a conduit comprising an upper opening and a lower opening, wherein water draining from the outer trough into the containment tank enters the conduit through the upper opening and leaves the conduit to enter the containment tank through the lower opening, and wherein, for each trough drain of the plurality of trough drains, the lower opening of the conduit is located above each weep drain of the plurality of weep drains. In one or more embodiments, at least one trough drain of the plurality of trough drains is aligned with each weep drain of the plurality of weep drains when moving along a horizontal axis extending through the at least one trough drain between the interior side and the exterior side of the sill. In one or more embodiments, at least one vent of the plurality of vents is aligned with each weep drain of the plurality of weep drains when moving along a horizontal axis extending through the at least one vent between the interior side and the exterior side of the sill. In one or more embodiments, at least one trough drain of the plurality of trough drains is aligned with each weep drain of the plurality of weep drains when moving along a horizontal axis extending through the at least one trough drain between the interior side and the exterior side of the sill; wherein at least one vent of the plurality of vents is aligned with each weep drain of the plurality of weep drains when moving along a horizontal axis extending through the at least one vent between the interior side and the exterior side of the sill; and wherein the at least one vent is aligned with the at least one trough drain when moving along a horizontal axis extending through the at least one vent between the interior side and the exterior side of the sill.

In one or more embodiments a method of controlling water captured in a sill of a fenestration unit as described herein, the conduit of each trough drain of the plurality of trough drains comprises a first conduit and wherein the trough drain comprises a second conduit comprising a second upper opening and a second lower opening, wherein a portion of water draining from the outer trough into the containment tank enters the second conduit through the second upper opening and leaves the second conduit to enter the containment tank through the second lower opening. In one or more embodiments, the method comprises passing a portion of air moving towards the interior side of the sill within the containment tank through an air vent located between the first conduit and the second conduit, wherein the air vent is located above the lower opening of the first conduit and the second lower opening of the second conduit. In one or more embodiments, the air vent is located in the containment tank below the outer trough. In one or more embodiments, at least one weep drain of the plurality of weep drains is aligned with the air vent when moving along a horizontal axis extending through the at least one weep drain between the interior side and the exterior side of the sill.

Where used herein, the terms “exterior” and “interior” are used in a relative sense, for example, an exterior surface and an interior surface may be used to describe surfaces located on opposite sides of a fenestration unit. In actual use, and exterior surface could be found within the interior of a building or other structure where the surface would conventionally be defined as an interior surface, while an interior surface could be found outside of a building or other structure where the surface would conventionally be defined as an exterior surface.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

The above summary is not intended to describe each embodiment or every implementation of the contain and drain sill systems, fenestration units incorporating them, and related methods as described herein. Rather, a more complete understanding of the invention will become apparent and appreciated by reference to the following Description of Illustrative Embodiments and claims in view of the accompanying figures of the drawing.

### BRIEF DESCRIPTION OF THE VIEWS OF THE DRAWING

Each of the figures described herein include axes corresponding to a three-dimensional Cartesian coordinate system to facilitate an understanding of the illustrative embodiments of the invention depicted in the figures and described herein.

FIG. 1 is an exploded perspective view of one illustrative embodiment of a fenestration unit including a contain and drain sill system as described herein.

FIG. 2 is an exploded perspective view of the frame of the fenestration unit depicted in FIG. 1.

FIG. 3 is a cross-sectional view of the sill of the fenestration unit depicted in FIGS. 1-2.

FIG. 4A is a cross-sectional view of the sill of the fenestration unit depicted in FIGS. 1-3 with water in the outer trough and a portion of a movable sash on the inner rail.

FIG. 4B is a cross-sectional view of the sill of the fenestration unit depicted in FIGS. 1-3 with water in both the interior and outer troughs and a portion of a sash on the outer rail.

FIG. 5 is a schematic diagram of the sill and fenestration unit of FIGS. 1 and 4A-4B depicting the exterior and interior drainage zones of the sill as defined by the inner and outer sashes.

FIG. 6 is a top view of one illustrative embodiment of a contain and drain sill of a fenestration unit as described herein.

FIG. 7 is a front view of the exterior side of the sill of FIG. 6.

FIG. 8 is an exploded perspective view of the contain and drain sill of FIGS. 6 and 7 including illustrative embodiments of air and water management components that can be used with the sill.

FIG. 9 is a perspective view of one illustrative embodiment of a trough drain insert that may be used in connection with the fenestration unit sill systems as described herein.

FIG. 10 is a front view of the trough drain insert depicted in FIG. 9.

FIG. 11 is a side view of the trough drain insert depicted in FIGS. 9-10.

FIG. 12 is a cross-sectional view of the sill of FIG. 8 taken in a Y-Z plane running through the trough drain, vent cover, and weep drain cover after assembly of those components with the sill illustrating fluid collection and air management of one or more embodiments of contain and drain sill systems as described herein.

FIG. 13 is a perspective view of a portion of one illustrative embodiment of a sill system for a fenestration unit as described herein.

FIG. 14 is an enlarged perspective view of one illustrative embodiment of a vent cover that may be used in the fenestration unit sill systems described herein.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

Although the illustrative embodiments described in connection with the figures are focused on contain and drain sill systems in windows, the contain and drain sill systems described herein may be used in connection with any fenestration unit (e.g., window, door, etc.) including a frame having a sill that includes a contain and drain water management system (where it is understood that the sill is the frame component installed at the bottom or lowermost portion of the fenestration unit). The fenestration units may, in one or more embodiments, include one or more panels in the form of one or more stationary sashes and/or one or more moving sashes. The doors may, in one or more embodiments, include one or more fixed panels and/or one or more moving panels. As installed, the fenestration units described herein have a frame that includes an exterior side and an interior side, where the exterior side typically (but not necessarily) faces the exterior of a building in which the fenestration units are installed and the interior side typically (but not necessarily) faces the interior of the building.

Various features of the contain and drain sill systems described herein are described using terms such as “below” and/or “above” and it should be understood that these terms are used to describe relative positions of the features in a fenestration unit as installed in a building with respect to the direction of gravity.

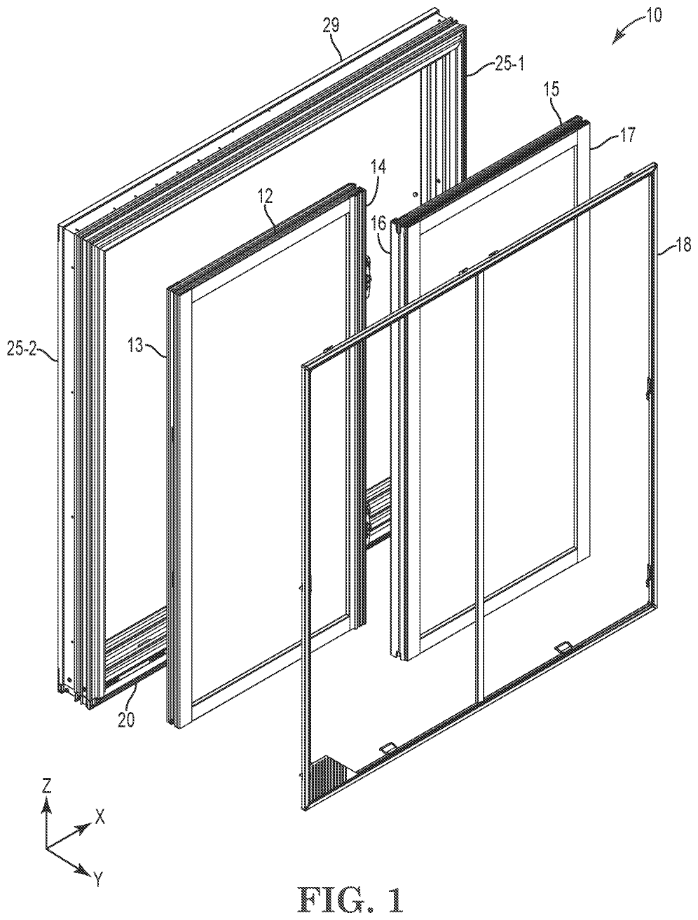

One illustrative embodiment of a window 10 incorporating a contain and drain sill system as described herein is depicted in FIG. 1. As a result, the window 10 will be described as having panels in the form of window sashes. It should, however, be understood that the principles described in connection with the window sashes in the illustrative embodiments would apply equally to any door panel provided in a door incorporating a contain and drain sill system as described herein.

The window 10 depicted in FIG. 1 includes a frame having a sill 20 along with a first side jamb 25-1 and a second side jamb 25-2. The frame also includes a head jamb 29 and the first and second side jambs 25-1 and 25-2 are connected to each other by the sill 20 and head jamb 29. The window 10 also includes a pair of sashes 12 and in the frame. In one or more embodiments, inner sash/panel 12 may be a movable panel that is configured for movement between the first and second side jambs 25-1 and 25-2 along a rail formed in the contain and drain sill as described herein, while outer sash/panel 15 may be stationary (fixed in place) within the frame. In one or more embodiments, the inner and outer sash positions may be reversed with outer sash 15 abutting side jamb 25-2 and inner sash 12 abutting side jamb 25-1 when the sashes of the window are closed. In one or more alternative embodiments, however, both inner sash 12 and outer sash 15 may move between the first and second side jambs 25-1 and 25-2 along rails in the sill 20 to open and close the window 10. In still other embodiments the outer sash 15 may move while the inner sash 12 is stationary or fixed within the fenestration unit frame. In the illustrative embodiment of window 10, an optional screen 18 is also included.

The inner sash 12 in the illustrative embodiment of window 10 as depicted in FIG. 1 includes edges 13 and 14, while the sash 15 includes edges 16 and 17. In one or more embodiments in which inner sash 12 is a movable panel and outer sash 15 is a stationary panel, the inner sash 12 may be moved between the first side jamb 25-1 and the second side jamb 25-2 such that edge 13 moves towards or away from the side jamb 25-2 while edge 14 moves towards or away from the side jamb 25-1. In an embodiment in which outer sash 15 is stationary, the edges 16 and 17 of outer sash 15 typically remain in a fixed location within the fenestration unit frame of the window 10. In one or more embodiments, the inner sash 12 and outer sash 15 may include sealing components or structures positioned at or near their respective inner edges 14 and 16 such that the sashes 12 and 15 form a weather tight seal with each other when the inner sash 12 is in its closed position in which edge 13 is located at and forms a seal with the side jamb 25-2.

In one or more alternative embodiments in which the outer sash 15 is also a movable sash configured for movement between the first side jamb 25-1 and the second side jamb 25-2, the outer sash 15 may be moved from a closed position in which edge 17 of the sash 15 is located at and forms a seal with the side jamb 25-1 and open position in which an opening is formed between edge 17 of sash 15 and side jamb 25-1.

The frame members, i.e., the sill 20, first and second side jambs 25-1 and 25-2, and a head jamb 29, described herein may be manufactured by a variety of processes. In one or more embodiments, however, the frame members may be manufactured of an extruded material which may include fibers and a polymer, pultruded materials, metals, etc. Examples of some potentially suitable constructions for frame members that may be used to construct window frames as described herein may include those described in, e.g., U.S. Pat. No. 5,585,155 (Heikkila et al.); U.S. Pat. No. 6,106,944 (Heikkila et al.); U.S. Pat. No. 6,210,792 Seethamraju et al.); U.S. Pat. No. 6,260,251 (Guhl); U.S. Pat. No. 6,280,667 (Koenig et al.); U.S. Pat. No. 6,342,172 (Finley); etc.

Frame members constructed in an extrusion or pultrusion process may include hollows or cavities formed along their length, with the walls and connecting structures of the frame members being formed of the extruded or pultruded material. In one or more embodiments, the hollows or cavities may be filled with one or more materials such as foam, etc. to, e.g., change the insulation characteristics and/or the structural rigidity of the frame members.

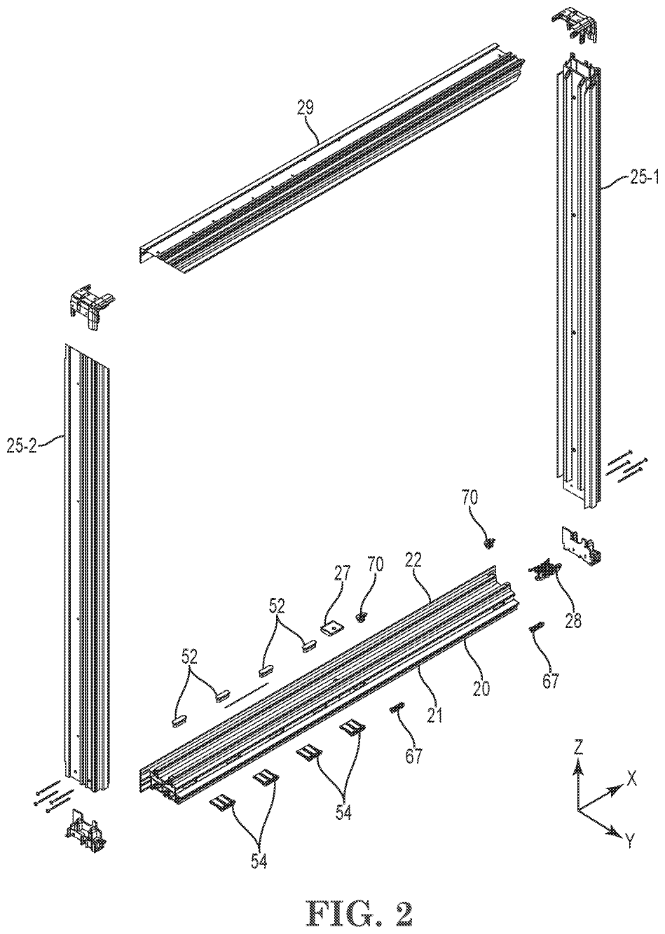

The frame members used to form the frame of the illustrative embodiment of window 10 are depicted in an exploded perspective view in FIG. 2. In particular, the first side jamb 25-1 is connected to the head jamb 29 using an optional corner key in the depicted illustrative embodiment. Similarly, the second side jamb 25-2 is also connected to the head jamb 29 using an optional corner key. The use of corner keys to connect frame members in windows and doors is known and will not be further described herein. The bottom ends of the first side jamb 25-1 and the second side jamb 25-2 include optional end connectors which can be used along with fasteners to attach the bottom ends of the first side jamb 25-1 and the second side jamb 25-2 to opposite ends of the sill 20. Although the illustrative embodiment of the frame formed by frame members 20, 25-1, 25-2, and 29 includes corner keys and end connectors along with threaded fasteners, in one or more alternative embodiments, the frames of fenestration units described herein may be constructed using any suitable techniques and/or components.

Another optional component that is also depicted in FIG. 2 is a trough dam 27 that limits movement of water within an outer trough formed in the sill 20. In one or more embodiments, the trough dam 27 may also assist in forming a seal in the outer trough of the sill 20 beneath the junction between the inner sash 12 and outer sash 15. Yet another optional component that is depicted in connection with sill 20 in FIG. 2 is a retainer 28 that, in one or more embodiments, is provided in a containment tank in the sill 20 to retain threaded or other fasteners driven through the sill 20 (along, e.g., the direction of the Z-axis). Unlike containment tank dams which may be placed in containment tanks of contain and drain sills to prevent water from moving within a containment tank between the ends of the sill 20, the retainer 28 allows water to flow through the containment tank in which it is positioned from the first side jamb 25-1 to the second side jamb 25-2 as described herein.

Also depicted in connection with the illustrative embodiment of sill 20 are weep drains 54 and 67 located along the exterior side of the sill 22 allow water within the containment tanks of the sill 20 to exit the containment tanks. Weep drains 54 located on one side of trough dam 27 are different than the weep drains 67 located on the opposite side of the trough dam 27. Similarly, trough drains 52 and 70 located on opposite sides of the trough dam 27 are also different. The two portions of sill 20 separated by the trough dam 27 correspond generally to the locations of the inner sash 12 and the outer sash 15 when the inner sash 12 and outer sash 15 are positioned such that the window is closed as described herein.

The contain and drain sill systems described herein are designed to remove water in the interior trough of the sill 20 as well as in the outer trough of the sill 20. The drain covers 52 and weep drain covers 54 found on the exterior side of the inner sash 12 when the inner sash 12 is in its closed position as described herein may, in one or more embodiments, be similar to the components described in U.S. Pat. No. 9,863,183 (Johnson, et al.). While those components work well for draining water found in the outer trough of a sill such as sill 20 on the exterior side of the inner sash 12, they do not provide the advantages associated with the trough drains 70 and associated components of the sill systems described herein in the portion of the sill 20 located on the interior side of a outer sash 15 as well as the interior side of the inner sash 12.

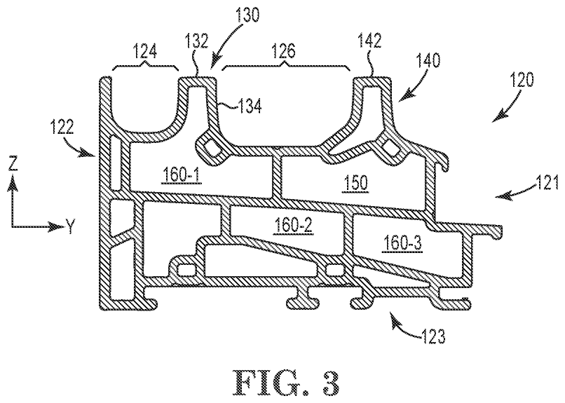

FIG. 3 is an end view of one illustrative embodiment of a sill 120 that may be used in one or more embodiments of the contain and drain sill systems described herein. The sill 120 includes an exterior side 121, an interior side 122 and a bottom 123. Bottom 123 is typically constructed to sit on the sill surface of a building opening (e.g., rough opening) in which a fenestration unit including is installed.

Sill 120 also includes an inner trough 124 and an outer trough 126. The inner trough 124 and outer trough 126 are separated from each other by an inner rail 130, while the outer trough 126 is further defined by an outer rail 140 located closer to the exterior side 121 of sill 120 than inner rail 130. Both the inner rail 130 and the outer rail 140 extend along a length of the sill 120 between first and second jambs (such as, e.g., jambs 25-1 and 25-2 in FIGS. 1-2) when the sill 120 forms a part of a fenestration unit frame.

The inner rail 130 includes a support surface 132 on which a sash is supported as described herein as well as an exterior wall 134. The exterior wall 134 faces the outer trough 126 as well as the exterior side 121 of the sill 120. The inner rail 130 supports an inner sash as described herein.

The outer rail 140 includes a support surface 142 on which a sash is supported as described herein. The outer rail 140 supports an outer sash as described herein. Also depicted in FIG. 3 are containment tanks that form a part of the water management system of sills as described herein. Containment tank 150 is provided beneath a portion of outer trough 126 as well as outer rail 140. Containment tank 160-1 is provided beneath a portion of inner trough 124 as well as a portion of outer trough 126 and inner rail 130. Containment tanks 160-2 and 160-3 are located below both containment tanks 160-1 and 150 and, as described herein, can be combined with containment tank 160-1 to form containment tank 160. It will be understood that the arrangement of containment tanks provided in sill 120 are exemplary in nature only and that sills 120 having different profiles may include different arrangements of containment tanks.

In one or more embodiments of the sills used in the contain and drain sill systems described herein, one or both of the containment tanks 150 extend along the length of the sill 120, i.e., from one side jamb to the opposite side jamb of the fenestration unit frame of which the sill 120 forms a part. One advantage of such a construction is that the volumes of the containment tanks are increased as compared to containment tanks including one or more internal plugs or seals designed to prevent water movement from one end of the sill to the other. That increased volume can help with controlling water drainage during extreme weather events such as, e.g., tropical storms, hurricanes, cyclones, thunderstorms, rainstorms, etc. as well as during cleaning or other events in which larger volumes of water are directed onto the fenestration units including the contain and drain sill systems described herein.

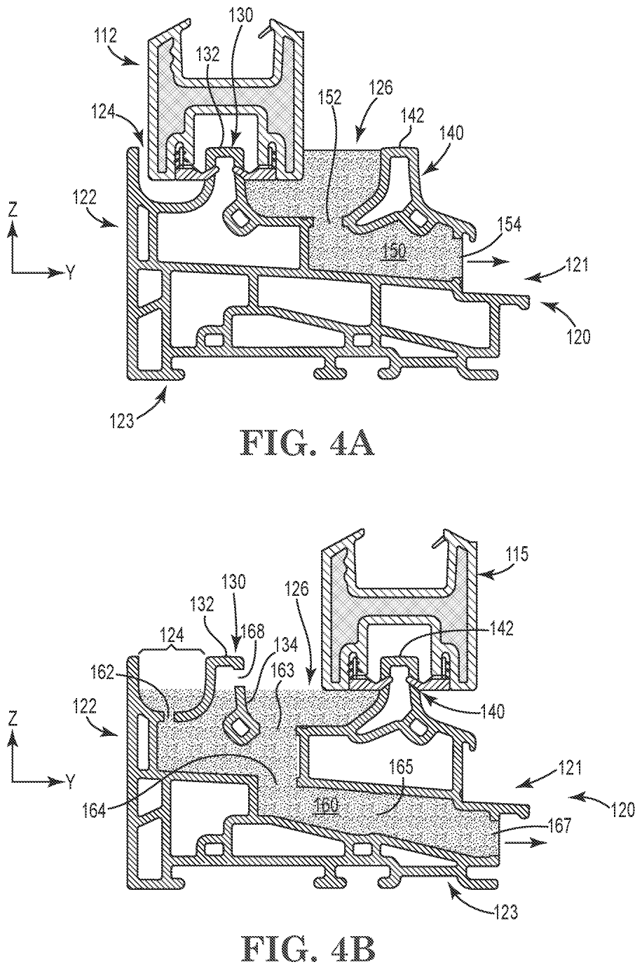

FIG. 4A is a cross-sectional view of sill 120 of FIG. 3 taken in the Y-Z plane at a selected location along a length of the sill 120 after modification to provide for drainage of the outer trough 126 in the portion of sill 120 occupied by an inner sash 112 when the sash is located in a closed position in a fenestration unit frame as described herein. As depicted in FIG. 4A, the inner sash 112 is supported on the inner rail 130 of sill 120 (the inner sash 112 may, in one or more embodiments, include rollers or other known structures not shown that act on the support surface 132 of inner rail 130 to support sash 112).

The modification to sill 120 involves forming an opening 152 in the bottom of the outer trough 126 with the opening 152 providing access to the containment tank 150. A second opening 154 is provided on an exterior side 121 of the sill 120. Drain opening 152 provides for drainage of water located in the outer trough 126, with the water passing through containment tank 150 and exiting containment tank 150 through drain opening 154. Components that may be used to manage the flow of water and air through containment tank 150 as well as outer trough 126 are described in U.S. Pat. No. 9,863,183 (Johnson, et al.). Unlike the drainage system described in U.S. Pat. No. 9,863,183 (Johnson, et al.), the containment tank 150 occupies the entire length of the of the sill which results in a significant increase in the volume of water that can be held and drained from the exterior portion of the outer trough 126 located on the exterior side of the inner sash 112.

FIG. 4B is a cross-sectional view of sill 120 of FIG. 3 taken in the Y-Z plane at a selected location along a length of the sill 120 after modification of sill 120 to provide for drainage of the outer trough 126 in the portion of sill 120 occupied by an outer sash 115 when the sash 115 is located on an opposite portion of the sill 120 from sash 112 to close a fenestration unit. As depicted in FIG. 4B, the outer sash 115 is supported on the outer rail 140 of sill 120 (the outer sash 115 may, in one or more embodiments, include rollers or other known structures not shown that act on the support surface 142 of outer rail 140 to support sash 115).

The drainage modifications to sill 120 involve forming a variety of openings in various portions of the sill 120 to facilitate the drainage of water from both a portion of the outer trough 126 as well as the inner trough 124. With reference to FIG. 3, the openings provided in the interior volume of the sill 120 include opening 164 used to connect containment tank 160-1 with containment tank 160-2 as well as opening 165 used to connect containment tank 160-2 with containment tank 160-3. Collectively, containment tanks 160-1, 160-2 and 160-3 form containment tank 160 in sill 120 as depicted in FIG. 4B. As with containment tank 150, in one or more embodiments, containment tank 160 extends over the full length of the sill 120 to increase the available volume for water management.

Also among the openings provided in sill 120 are opening 162 in inner trough 124 to allow water located in the inner trough 124 to drain into the containment tank 160 as well as opening 163 in outer trough 126 to allow water located in the outer trough 126 to drain into the containment tank 160. A drain opening 167 is provided on an exterior side of the sill 120 to allow water located in containment tank 160 to exit the sill 120. The openings in sill 120 also include a vent opening 168 provided in exterior wall 134 of inner rail 130 with, as described herein, vent opening 168 providing a pathway for air trapped in the containment tank 160 to escape as described herein. With reference to FIG. 4B, it can be seen that the water column height achievable on the inner trough 124 as well as the portion of outer trough 124 located on the interior side of the outer sash 115 is increased by moving the drain opening 167 to a location below containment tank 150 and its drain opening 154. This is accomplished while still maintaining a kerf below containment tank 160 and its opening 167 for the attachment of trim accessories to the sill 120.

The increased water column height provided by the lower drain opening 167 may facilitate faster and/or more effective drainage of the portion of outer trough 126 located on the interior side of the outer sash 115 as well as the inner trough 124. Faster and/or more effective drainage may be desirable because, for example, water located in that portion of outer trough 126 as well as inner trough 124 may be visible to a person on the interior side of a fenestration unit.

Also with reference to FIG. 4B, modification of a sill 120 to drain the outer trough 126 on the interior side of an outer sash 115 (as well as inner trough 124) through containment tank 160 can be provided by drilling, milling, routing, etc. the openings from the top side and exterior side of sill 120. In particular, access to form openings 163 and 164 can be provided through outer trough 126 while openings 165 and 167 can be provided by inserting a bit or other material removal tool through the portion of sill 120 containing opening 167 to reach opening 165. Similarly, vent opening 168 and an exterior wall 134 of inner rail 130 can be provided through outer trough 126 while opening 162 in inner trough 124 can be provided through inner trough 124.

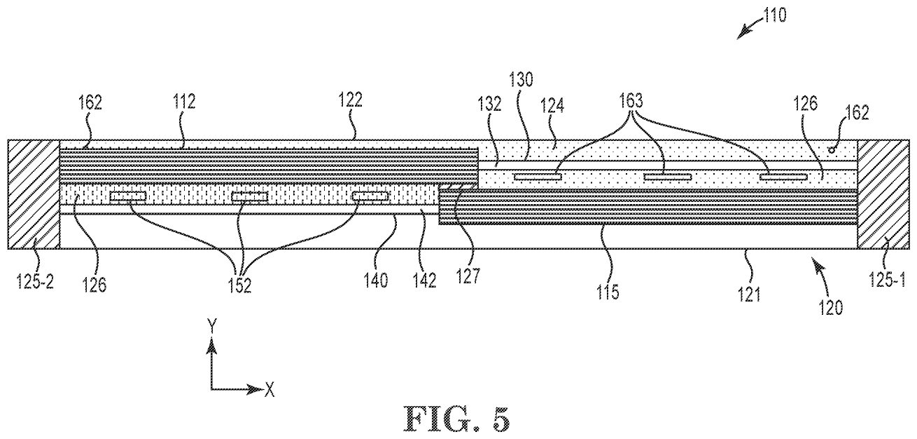

FIG. 5 is a schematic diagram of the sill and fenestration unit 10 of FIG. 1 and the sill of FIGS. 4A-4B depicting exterior and interior drainage zones of the sill as defined by the inner and outer sashes. As described herein, sill 120 includes an exterior side 121 and an interior side 122, the sill extending between side jambs 125-1 and 125-2. The sill 120 also includes an inner trough 124 and outer trough 126, with the inner trough 124 being located between the interior side 122 of the sill 120 and the inner rail 130. Outer trough 126 is located between inner rail 130 and outer rail 140. Inner sash 112 is supported on inner rail 130 and outer sash 115 is supported on outer rail 140 as described herein.

Also depicted in FIG. 5 is a seal 127 formed between the overlapping portions of inner sash 112 and outer sash 115. Seal 127 may also be provided within outer trough 126 beneath the overlapping portions of inner sash 112 and outer sash 115 to limit or prevent water located within the outer trough 126 on the exterior side of inner sash 112 from flowing into the portion of outer trough 126 located on the interior side of outer sash 115.

The portion of outer trough 126 located on the exterior side of inner sash 112 may be described as an exterior portion of outer trough 126 (or, alternatively, as an exterior drainage zone) because that portion of outer trough 126 is on the exterior side of the fenestration unit 110. Water collected in the exterior portion of outer trough 126 is drained into containment tank 150 (see, e.g., FIG. 4A) through openings 152 located in exterior portion of outer trough 126 as described herein. In the schematic diagram of FIG. 5, the exterior portion of the outer trough 126 is represented by the area occupied by vertical hashmarks in the outer trough 126 on the exterior side of the inner sash 112.

The portion of outer trough 126 located on the interior side of outer sash 115 may be described herein as an interior portion of outer trough 126. The interior portion of outer trough 126 and the entire inner trough 124 may, collectively, be described as an interior drainage zone in one or more embodiments of the containment drain sill systems described herein. Both the inner trough 124 and the interior portion of outer trough 126 drain into containment tank 160 (see, e.g., FIG. 4B) through openings 163 located in the interior portion of outer trough 126 as described herein. In the schematic diagram of FIG. 5, the interior portion of the outer trough 126 is represented by the area occupied by a dotted pattern in in the outer trough 126 on the exterior side of the inner sash 112. The inner trough 124 also includes the same dotted pattern because, as described herein, the inner trough 124 and interior portion of outer trough 126 collectively form an interior drainage zone for fenestration unit 110.

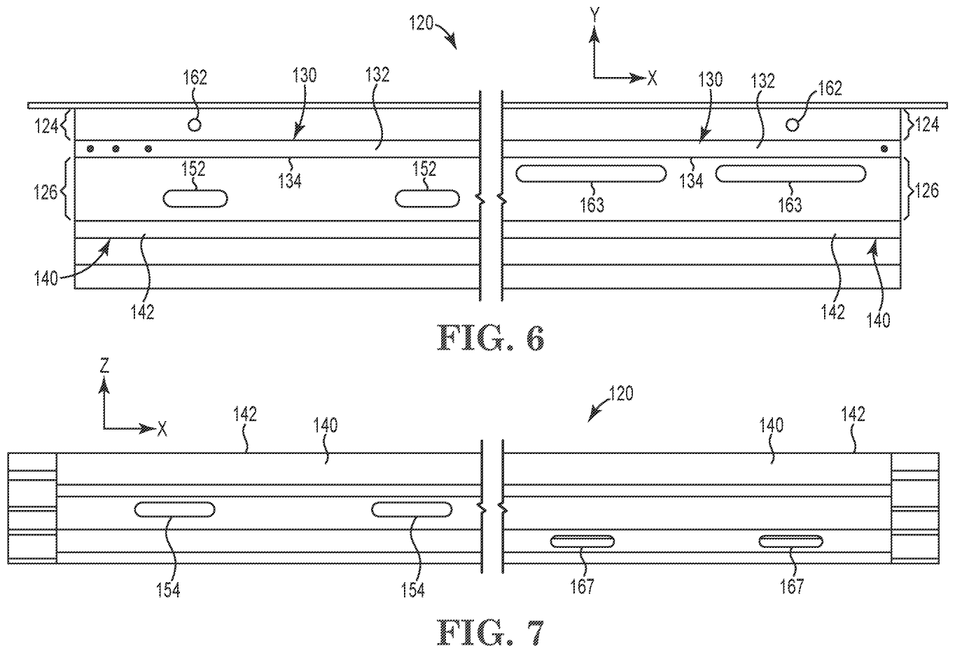

FIGS. 6 and 7 are, respectively, top and front side views of the sill 120 as depicted in FIGS. 3 and 4. FIGS. 6 and 7 depict both portions of the sill 120, i.e., the left side portion on which the inner sash 112 is located as well as the right-side portion on which the outer sash 115 is located. These portions (and their respective drainage features) may, of course, be reversed in other fenestration units with the reversal of the sashes 112 and 115.

As described herein, includes an inner trough 124 as well as an outer trough 126 with inner rail 130 being located between the inner trough 124 and the outer trough 126. Inner rail 130 includes a support surface 132 on which a sash is supported as described herein. Sill 120 also includes outer rail 140 having a support surface 142 on which a sash is supported as described herein.

With reference to the right side portion of sill 120 as depicted in FIG. 6, both opening 162 in inner trough 124, which allows water located in the inner trough 124 to drain into the containment tank 160, as well as openings 163 in outer trough 126 which allow water located in the outer trough 126 to drain into the containment tank 160 as depicted in, e.g., FIG. 4B. In the depicted embodiment, the outer trough 126 includes a pair of openings 163. It should be understood that any number of openings 163 may be provided in the portion of an outer trough of a sill located on an interior side of an outer sash as used in a fenestration unit as described herein.

With reference to the left side portion of sill 120 as depicted in FIG. 6, openings 152 which allow water located in the outer trough 126 to drain into the containment tank 150 as depicted, e.g., in FIG. 4A. In the depicted embodiment, the left side portion of outer trough 126 includes a pair of openings 152. It should be understood that any number of openings 152 may be provided in the portion of an outer trough of a sill located on an exterior side of an inner sash as used in a fenestration unit as described herein.

Although not depicted in FIG. 4A, the left side portion of sill 120 also includes an opening 162 in inner trough 124 which allows water located in the inner trough 124 to drain into the containment tank 160. In the depicted illustrative embodiment of sill 120 only a pair of openings 162 are provided in the inner trough 124 although it should be understood that in one or more alternative embodiments, as few as one opening 162 or more than two openings 162 may be provided in the inner trough 124. In one or more embodiments, openings 162 in inner trough 124 may be positioned closer to the opposite ends of the sill 120, although any suitable placement and/or arrangement of openings into the containment chamber 160 from the inner trough 124 may be provided.

With reference to the right-side portion of sill 120 as depicted in FIG. 7, drain openings 167 are provided in the exterior side of sill 120 to allow water in the containment chamber 160 to escape from the containment chamber 160 as discussed above in connection with, e.g., FIG. 4B. Also depicted in FIG. 7 are the outer rail 140 and its support surface 142.

With reference to the left side portion of sill 120 as depicted in FIG. 7, drain openings 154 are provided in the exterior side of sill 120 to allow water in the containment chamber 152 escape from the containment chamber 160 as discussed above in connection with, e.g., FIG. 4A. Also depicted in FIG. 7 are the outer rail 140 and its support surface 142.

While openings 163 in outer trough 126 located on the interior side of an outer sash of a fenestration unit as described herein provide drainage of water in that portion of outer trough 126 into containment tank 160, the openings 163 do not provide for management of the passage of air into or out of the containment chamber 160.

Uncontrolled air movement through containment tank 160 may result in undesirable sputtering of water during, e.g., high wind events that results in air entering containment chamber 160 through drain openings 167.

Illustrative embodiments of various components that may be used in connection with sill 120 to control air movement within the containment tank 160 are depicted in FIG. 8 which is an exploded diagram of sill 120 and the components provided to assist with air management as described herein.

FIG. 8 does also depict components that may be similar in many respects to the components described in U.S. Pat. No. 9,863,183 (Johnson et al.) used to manage air and water flow within containment tank 150 on the exterior side of an inner sash located on sill 120. Those components include drain covers 152-1 positioned in openings 152 on the left side portion of the sill 120 as depicted in FIG. 6 as well as weep drain covers 154-1 positioned in drain openings 154 on the exterior side 121 of sill 120. These components will not be further described herein.

With respect to the right-side portion of which is the portion located on the interior side of an outer sash found on outer rail 140, the contain and drain sill systems of fenestration units as described herein may include trough drains 170 for placement in openings 163 in outer trough 126. In the depicted illustrative embodiment, the openings 163 and their respective trough drains 170 are located closer to the inner rail 130 than the outer rail 140 when moving along a horizontal axis (i.e., the Y-axis) extending between the interior side and the exterior side of the sill 120. Vent covers 180 for placement in vent openings 168 in the exterior wall 134 of inner rail 130 are also depicted in FIG. 8.

Weep drain covers 167-1 are also depicted for placement in drain openings 167. The weep drain covers 167-1 may include features such as flaps, etc. designed to limit the intrusion of debris, insects, etc. into the containment tank 160. Such covers are known and will not be described further herein.

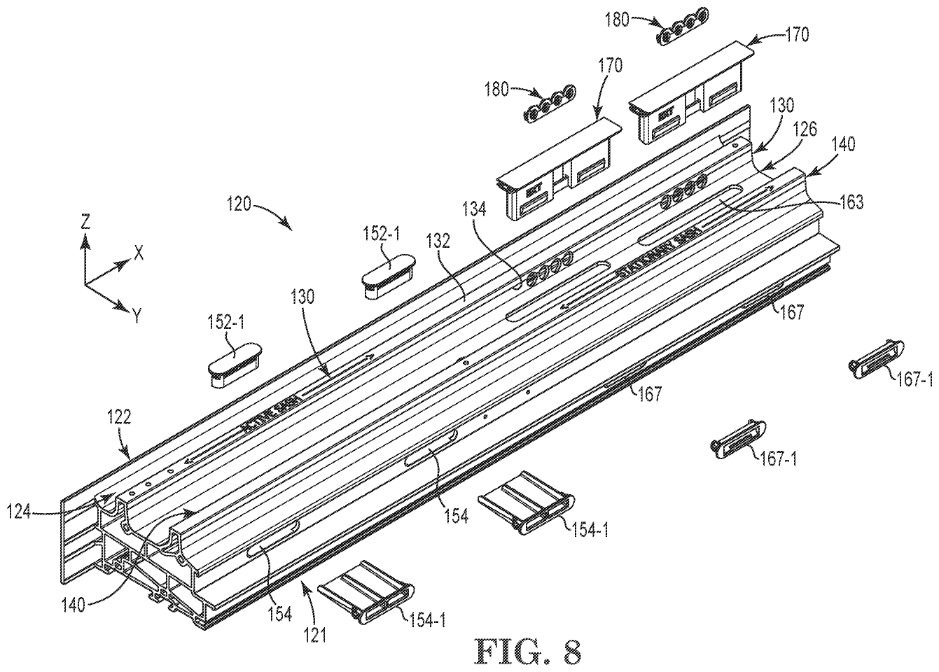

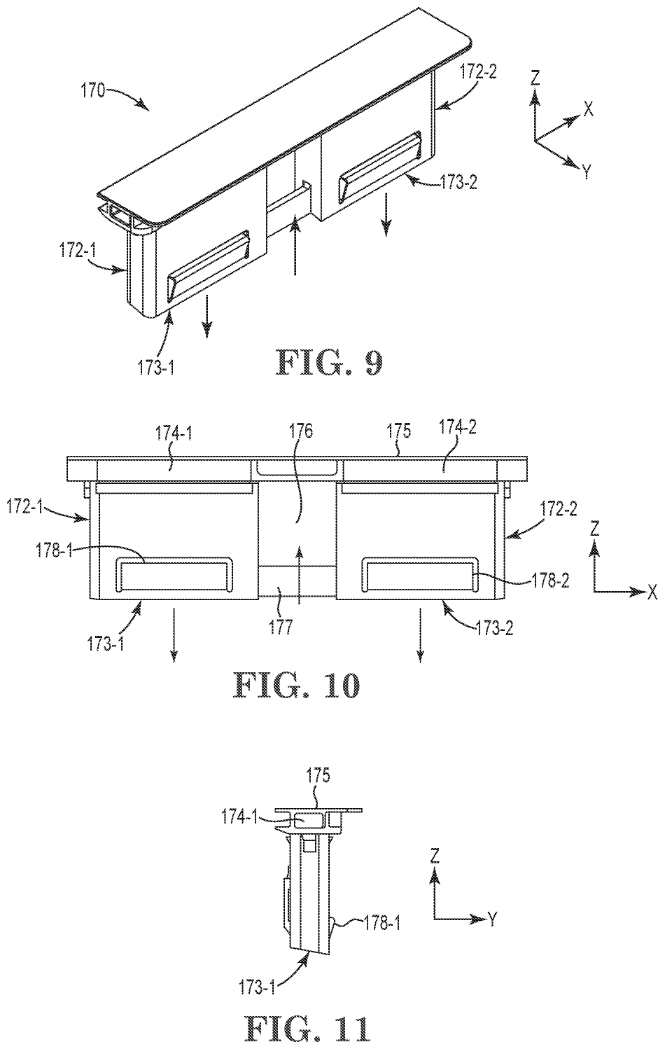

One illustrative embodiment of a trough drain 170 that may be used in one or more embodiments of contain and drain sill systems as described herein is depicted in FIGS. 9-11. In one or more embodiments, the trough drains may provide for separation of flow between water and air moving through the containment tanks of sills of contain and drain sill systems as described herein.

The depicted illustrative embodiment of trough drain 170 includes a pair of conduits 172-1 and 172-2 (which may be referred to collectively as conduits 172).

Conduit 172-1 includes an upper opening 174-1 and a lower opening 173-1 with the conduit 172-1 allowing for the flow of a fluid through the conduit 172-1. Similarly, conduit 172-2 includes an upper opening 174-2 and a lower opening 173-2 with the conduit 172-2 allowing for flow of fluid through the conduit 172-2.

A cap 175 may be provided above the upper openings 174-1 and 174-2 as depicted in the illustrative embodiment of trough drain 170. 174 may, for example, prevent debris from easily entering the conduits 172 as well as providing for a more aesthetic appearance when the trough drain 170 is positioned in a sill 120 as described herein.

While conduits 172 are configured to provide for the passage of water from the portion of the outer trough 126 located on the interior side of an outer sash on outer rail 140 into the containment tank 160, the depicted illustrative embodiment of trough drain 170 also includes an air vent 176 located between conduits 172-1 and 172-2. The air vent 176 may, in one or more embodiments, be located below the upper openings 174-1 and 174-2 of the conduits 172 and above the lower openings 173-1 and 173-2 of the conduits 172. As a result, air vent 176 is itself, preferably located in containment tank 160 below outer trough 126 when trough drain 170 is positioned in an opening 163 in the outer trough 126. The depicted embodiment of trough drain 170 also includes a strut 177 extending between the conduits 172-1 and 172-2 to, for example, maintain proper spacing between the conduits 172.

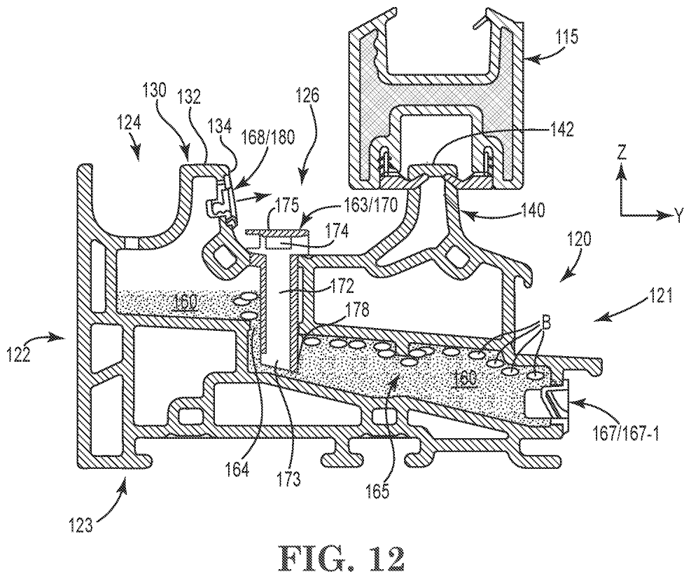

FIG. 12 is a cross-sectional view of the sill 120 as depicted in FIG. 8 taken in the Y-Z plane through the trough drain 170 and vent cover 180 as well as weep drain cover 167-1. In addition, an outer sash 115 is positioned on outer rail 140 in the cross-sectional view of FIG. 12.

As depicted in FIG. 12, the trough drain 170 positioned in opening 163 of outer trough 126 on the interior side of the outer sash 115 includes an upper opening 174 and a lower opening 173. Upper opening 174 is proximate the opening 163 in outer trough 126 while lower opening 173 is positioned in the containment tank 160. In one or more embodiments, it may be preferred that the lower opening 173 of the conduit provided by trough drain 170 be located as close as possible to the bottom of containment tank 160 (where the bottom of containment tank 160 is the surface of containment tank 160 closest to the bottom 123 of sill 120. Positioning the lower opening 173 of the conduit of trough drain 170 as low as possible within containment tank 160 helps to limit the entry of air into the conduit 172 through lower opening 173.

The trough drain 170 preferably forms a seal with opening 163 such that air and water passage between the outer surfaces of the trough drain 170 and the edges of opening 163 is limited or prevented. Trough drain 170 also includes features such as wedge 178 (see, e.g., wedges 178-1 and 178-2 in FIGS. 10-11) located and configured to interact with the interior surfaces of containment tank 160 such as an edge of opening 164 to retain the trough drain 170 within opening 163 in outer trough 126.

As discussed herein, the contain and drain sill systems provide for air management as well as water drainage. In particular, air may be found in containment tank 160 when containment tank 160 is not filled with water and, further, air may enter containment tank 160 through weep drain cover 167-1 and/or drain opening 167 even when water is located within containment tank 160 (due, for example, to wind, etc.). As depicted in FIG. 12 is represented by bubbles B. When water is present in containment tank 160, air naturally rises through the water. As a result, when containment tank 160 is filled with water to a location above the lower opening 173 of conduit 172 of trough drain 170 any air in the water in containment tank 160 will seek the highest level of that water.

As described in connection with FIGS. 9-10, one or more embodiments of trough drains used in contain and drain sill systems as described herein may include an air vent to facilitate passage of water past the trough drain. With respect to the illustrative embodiment of trough drain 170, the air vent 176 between conduits 172 provides a convenient passageway for air to flow from the lower portions of the containment tank 160 to the upper portions of the containment tank 160. Air passing through the containment tank 160 may exit the containment tank 160 through vent openings 168 formed provided in the inner rail 130 as described herein.

Although some air may, of course, escape from the containment tank 160 through the openings 162 at the ends of the inner trough 124, those openings 162 are not typically large enough to provide the air flow needed for proper drainage of the containment tank 160. To provide sufficient venting of air from the containment tank 160 depicted illustrative embodiment of sill 120 includes vent openings 168. The illustrative embodiments of vent openings 168 are depicted in FIGS. 5, 8, 12, and 13.

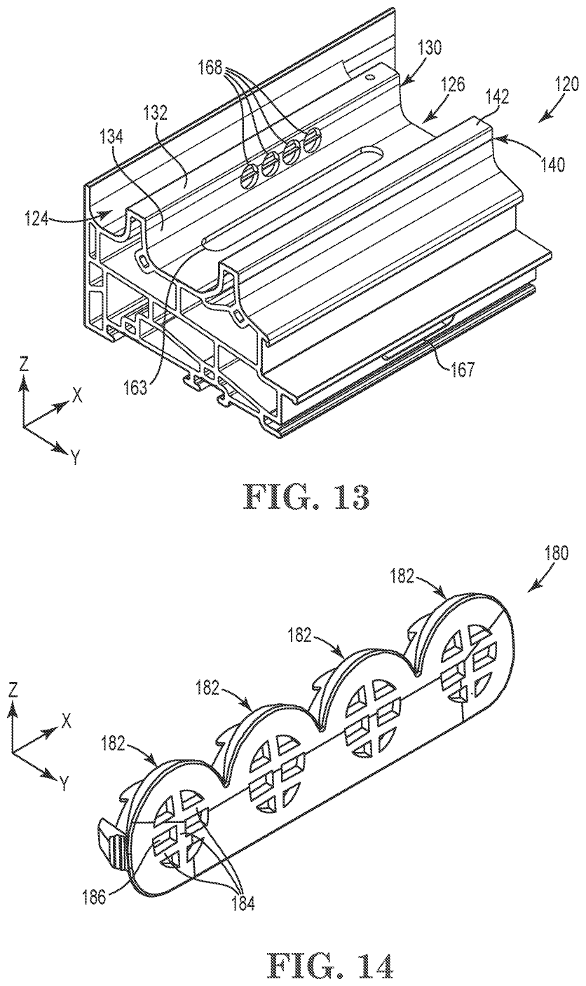

With reference to the vent openings 168 as depicted in FIGS. 12 and 13, the vent openings 168 extend through a wall of the inner rail 130 and are in fluid communication with the containment tank 160. In particular, the depicted illustrative embodiments of vent openings 168 extend through the exterior wall 134 of inner rail 130. More particularly, the vent openings 168 may be located below the upper support surface 132 of inner rail 130 and above a bottom of the outer trough 126. Further, the vent openings 168 are separate and discrete from the opening 163 and the trough drain 170 located in opening 163. Although depicted in the exterior wall 134 of inner rail 130, the vent openings 168 could alternatively be located on the interior wall of the inner rail 130 (i.e., the wall facing the interior side of the sill 120).

Locating the vent openings 168 in a wall of the inner rail 130 rather than the support surface 132 may reduce or prevent any issues associated with movement of a sash or other panel along the length of the inner rail 130 supported on the support surface 132. Further, for example, openings on the support surface 132 of inner rail 130 could potentially be blocked by rollers or other support apparatus of any such sash or panel supported on inner rail 130.

In addition, locating the vent openings 168 in the exterior wall 134 of inner rail 130 may provide aesthetic advantages because the vent openings are less visible from the interior side of a fenestration unit incorporating the sill systems described herein. Further, any water escaping through the vent openings 168 would be directed away from the interior side of the sill 120.

FIG. 14 depicts one illustrative embodiment of vent covers 182 that may be positioned in or over the vent openings 168 in inner rail 130 of sill 120. The depicted illustrative embodiments of vent covers 182 include grates 184 extending across the vent opening 168 such that small are apertures 186 are provided. Those smaller apertures may, in one or more embodiments, be sized to limit the passage of water in the form of droplets or bubbles out of the vent openings 168 and into the outer trough 126.

In the depicted illustrative embodiment, a series of vent openings 168 are provided rather than a single larger opening that would theoretically provide the same level of venting. Using a series of vent openings 168 as depicted in, e.g., FIG. 13, may be structurally superior to limit any potential issues with support of a sash by inner rail 130.

With reference to FIGS. 6-8 and 12, one or more embodiments of the contain and drain sill systems of fenestration units as described herein may include air and water management features that are aligned to enhance both air venting and water drainage.

For example, in one or more embodiments at least one vent opening 168 is aligned with each trough drain 170 and its corresponding opening 163 when moving along a horizontal axis extending through the vent opening 168 between the interior side 122 and the exterior side 121 of the sill 120. In one or more embodiments, 2 or more vent openings 168 may be aligned with each trough drain 170 and its corresponding opening 163 when moving along the horizontal axis to ensure sufficient venting of air from the containment tank 160. The horizontal axis corresponds with the Y-axis as depicted in the Cartesian coordinate systems provided in the figures.

With reference to FIGS. 9 and 10 in addition to FIGS. 6-8 and 12, in one or more embodiments of contain and drain sill systems of fenestration units as described herein an air vent 176 provided in a trough drain 170 may be aligned with at least one vent opening 168 when moving along the horizontal axis to provide an efficient path for air moving through the containment tank to reach the vent openings 168.

One or more embodiments of the contain and drain sill systems of fenestration units as described herein may also include trough drains 170 and their associated openings 163 that are aligned with weep drains 167 formed in the exterior side of the sill 120 when moving along the horizontal axis to provide an efficient path for air moving through the containment tank 160 from weep drains 167 particularly in embodiments in which the trough drains 170 include an air vent 176 as described herein.

Still further, at least one vent opening 168 may also be aligned with the weep drain 167 such that air entering the containment tank 160 from a weep drain 167 passes along a generally straight line through containment tank 160 and air vent 176 in trough drain 170 to reach vent opening 168. Such alignment of the air and water management features can enhance both air venting and water drainage.

The various components used in the contain and drain sill systems described herein may be constructed of any suitable material or combination of materials including polymers, metals, composites, wood, ceramics, etc. The particular materials used need only perform the functions of the various components as described herein and suitable choices for the materials will be known to those of skill in the art.

The complete disclosure of the patents, patent documents, and publications identified herein are incorporated by reference in their entirety as if each were individually incorporated. To the extent there is a conflict or discrepancy between this document and the disclosure in any such incorporated document, this document will control.

Illustrative embodiments of contain and drain sill systems, fenestration units incorporating them, and related methods are discussed herein with some possible variations described. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof. It should also be understood that this invention also may be suitably practiced in the absence of any element not specifically disclosed as necessary herein.

1. A contain and drain sill system for a fenestration unit, the system comprising:
a window or door frame comprising a first side jamb and a second side jamb connected to each other by a head jamb and a sill, wherein the sill and the frame comprise an interior side and an exterior side;
an inner panel retained in the frame, the inner panel positioned above the sill and between the first side jamb and the second side jamb;
an outer panel retained in the frame, the outer panel positioned above the sill and between the first side jamb and the second side jamb;
an inner rail extending along a length of the sill between the first side jamb and the second side jamb, wherein the inner panel is supported by the inner rail;
an outer rail extending along a length of the sill between the first side jamb and the second side jamb, wherein the outer panel is supported by the outer rail, wherein the outer rail is located between the inner rail and the exterior side of the sill;
an inner trough located in the sill, the inner trough located between the interior side of the sill and the inner rail;
an outer trough located in the sill, the outer trough located between the inner rail and the outer rail;
a containment tank located in the sill, wherein the containment tank is located below the inner rail, the outer trough and at least a portion of the inner trough;
a plurality of trough drains located in the outer trough between the outer panel and the inner trough, wherein each trough drain of the plurality of trough drains is configured to drain water in the outer trough into the containment tank, wherein each trough drain comprises a conduit comprising an upper opening and a lower opening, wherein water draining from the outer trough into the containment tank enters the conduit through the upper opening and leaves the conduit to enter the containment tank through the lower opening; and
a plurality of vents in the sill, wherein each vent of the plurality of vents comprises a vent opening extending through an exterior wall of the inner rail and is in fluid communication with the containment tank.

2. A contain and drain sill system according to claim 1, wherein the containment tank extends along the length of the sill from the first side jamb to the second side jamb.

3. A contain and drain sill system according to claim 1, wherein each vent opening of the plurality of vents is located below an upper support surface of the inner rail and above a bottom of the outer trough.

4. A contain and drain sill system according to claim 1, wherein at least one vent opening is aligned with each trough drain of the plurality of trough drains when moving along a horizontal axis extending through the at least one vent between the interior side and the exterior side of the sill.

5. A contain and drain sill system according to claim 4, wherein the at least one vent opening aligned with each trough drain is located above the trough drain, and wherein the at least one vent opening is separate and discrete from the trough drain with which the at least one vent opening is aligned.

6. A contain and drain sill system according to claim 1, wherein two or more vent openings of the plurality of vents are aligned with each trough drain of the plurality of trough drains when moving along a horizontal axis extending through the two or more vent openings between the interior side and the exterior side of the sill.

7. A contain and drain sill system according to claim 6, wherein the two or more vent openings aligned with each trough drain are located above each trough drain, and wherein the two or more vent openings are separate and discrete from the trough drain with which the two or more vent openings are aligned.

8. A contain and drain sill system according to claim 1, wherein the conduit of each trough drain of the plurality of trough drains comprises a first conduit and wherein the trough drain comprises a second conduit comprising a second upper opening and a second lower opening, wherein a portion of water draining from the outer trough into the containment tank enters the second conduit through the second upper opening and leaves the second conduit to enter the containment tank through the second lower opening.

9. A contain and drain sill system according to claim 8, wherein the first conduit and the second conduit are separated from each other by an air vent located between the first conduit and the second conduit, wherein the air vent is located below the upper opening of the first conduit and the second upper opening of the second conduit, and wherein the air vent is located above the lower opening of the first conduit and the second lower opening of the second conduit.

10. A contain and drain sill system according to claim 9, wherein the air vent is located in the containment tank below the outer trough.

11. A contain and drain sill system according to claim 1, wherein the sill comprises a plurality of weep drains in fluid communication with the containment tank such that water in the containment tank drains out of the containment tank through the plurality of weep drains under the force of gravity, wherein the plurality of weep drains are located on the exterior side of the sill, and wherein, for each trough drain of the plurality of trough drains, the lower opening of the conduit is located above each weep drain of the plurality of weep drains.

12. A contain and drain sill system according to claim 11, wherein at least one trough drain of the plurality of trough drains is aligned with each weep drain of the plurality of weep drains when moving along a horizontal axis extending through the at least one trough drain between the interior side and the exterior side of the sill.

13. A contain and drain sill system according to claim 11, wherein at least one vent opening is aligned with each weep drain of the plurality of weep drains when moving along a horizontal axis extending through the at least one vent opening between the interior side and the exterior side of the sill.

14. A contain and drain sill system according to claim 11, wherein the conduit of each trough drain of the plurality of trough drains comprises a first conduit and wherein the trough drain comprises a second conduit comprising a second upper opening and a second lower opening, wherein a portion of water draining from the outer trough into the containment tank enters the second conduit through the second upper opening and leaves the second conduit to enter the containment tank through the second lower opening.

15. A contain and drain sill system according to claim 14, wherein the first conduit and the second conduit are separated from each other by an air vent located between the first conduit and the second conduit, wherein the air vent is located below the upper opening of the first conduit and the second upper opening of the second conduit, and wherein the air vent is located above the lower opening of the first conduit and the second lower opening of the second conduit.

16. A contain and drain sill system according to claim 15, wherein the air vent is located in the containment tank below the outer trough.

17. A method of controlling water captured in a sill of a fenestration unit, the method comprising:
draining water collected in an outer trough of a sill to a containment tank, wherein the outer trough is located between an inner rail and an outer rail, wherein the inner rail and the outer rail both extend along a length of the sill, wherein the inner rail supports an inner panel of the fenestration unit and the outer rail supports an outer panel of the fenestration unit, and wherein the draining occurs through a plurality of trough drains located in the outer trough between an outer panel and the inner rail, and wherein the containment tank is located below the inner rail of the sill and the outer trough;
draining water from the containment tank to an exterior side of the sill through a plurality of weep drains in the sill; and
venting air from the containment tank through a plurality of vents, wherein each vent of the plurality of vents comprises a vent opening extending through a wall of the inner rail that is in fluid communication with the containment tank.

18. A method according to claim 17, wherein the containment tank extends along the length of the sill.

19. A method according to claim 17, wherein each trough drain of the plurality of trough drains is located closer to the inner rail than an outer rail when moving along a horizontal axis extending between the interior side and the exterior side of the sill, wherein the outer rail is located between the outer trough and the exterior side of the sill.

20. A method according to claim 17, wherein at least one vent of the plurality of vents is aligned with each trough drain of the plurality of trough drains when moving along a horizontal axis extending through the at least one vent between the interior side and the exterior side of the sill.

21. A method according to claim 17, wherein two or more vents of the plurality of vents are aligned with each trough drain of the plurality of trough drains when moving along a horizontal axis extending through the two or more vents between the interior side and the exterior side of the sill.

22. A method according to claim 17, wherein each trough drain comprises a first conduit and a second conduit, wherein a portion of water draining from the outer trough into the containment tank passes through the first conduit or the second conduit, and wherein a portion of air in the containment tank passes through an air vent located between the first conduit and the second conduit when moving towards the interior side of the sill.

23. A method according to claim 17, wherein each trough drain of the plurality of trough drains comprises a conduit comprising an upper opening and a lower opening, wherein water draining from the outer trough into the containment tank enters the conduit through the upper opening and leaves the conduit to enter the containment tank through the lower opening, and wherein, for each trough drain of the plurality of trough drains, the lower opening of the conduit is located above each weep drain of the plurality of weep drains.
